(19) United States
(12) Patent Application Publication
(10) Pub. No.: US 2003/0146650 A1
(43) Pub. Date: Aug. 7, 2003

(54) Sunshade assembly for a vehicle roof

(76) Inventors: Thorsten Paul, Lorzweiler (DE); Martin Messerschmidt, Mainz (DE)

Correspondence Address: CARLSON, GASKEY & OLDS, P.C., 400 WEST MAPLE ROAD, SUITE 350, BIRMINGHAM, MI, 48009, US

(21) Appl. No.: 10/360,595

(22) Filed: Feb. 7, 2003

(30) Foreign Application Priority Data
Feb. 7, 2002 (DE) 102 05 068.6

(51) Int. Cl. B60J 7/00

(52) U.S. Cl. 296/214

(57) ABSTRACT

A sunshade assembly for a vehicle roof has a first guide rail and a spaced second guide rail. A sunshade is movable relative to the first guide rail and the second guide rail between an open position and a closed position. The sunshade has a first lateral edge supported by the first guide rail and a second lateral edge supported by the second guide rail. A first sliding element moves within the first guide rail and supports the first lateral edge on the first guide rail. A second sliding element moves within the second guide rail and supports the second lateral edge to the second guide rail. A collection space receives the sunshade in the open position.

This application claims priority to Federal Republic of Germany Patent Application No. 102 05 068.6 filed Feb. 07, 2002.

### TECHNICAL FIELD

The invention relates to a sunshade assembly for a vehicle roof.

### BACKGROUND OF THE INVENTION

A translucent opening of a vehicle roof may employ a sunshade assembly or, as more commonly known, a sunshade blind. The translucent opening may be, for instance, a stationary panoramic window or else a transparent cover for a sliding roof. The sunshade blind shifts between an open position that allows light to pass freely through the opening and a closed position that blocks or attenuates the light. Depending on its construction, the sunshade blind may be stopped in various intermediate positions between the closed and open positions.

Conventional sunshade blinds use a sunshade made of cloth, which is wound on a shaft when the sunshade is in the open position. This shaft is straight to permit its rotation. However, since a vehicle sunroof is typically arched, the straight shaft limits the amount of available headroom in the vehicle interior.

### BRIEF SUMMARY OF THE INVENTION

According to the invention, a sunshade assembly for a vehicle roof comprises a sunshade and two guide rails. The sunshade shifts along the two guide rails between an open position and a closed position. In the closed position, the sunshade extends across the guide rails, while in the open position the sunshade shifts into a collecting space that stores the sunshade.

The sunshade has lateral edges and may be made of a bendable material capable of bearing a tensile load. Sliding elements attached to the lateral edges facilitate movement of the sunshade along its guide rails. The sliding elements are connected to each other by a flexible connection. When opened, the sunshade is stored in the collecting space. The collecting space may have a contour to match the contour of the roof so as to maximize headroom space.

Preferably, the sliding elements are made of plastic and are applied to the lateral edges of the sunshade by injection molding to minimize manufacturing expense. The sunshade may be made of fabric or plastic. At least one of the sliding elements of a lateral edge of the sunshade is connected to an opposite sliding element of the other lateral edge of the sunshade by an arch. In this way, the profile of the sunshade can accommodate the contour of the vehicle roof to maximize vehicle headroom.

According to a preferred embodiment, the sliding elements have teeth, which match teeth on a parallel operating cable set in a guide rail. The teeth of the sliding elements engage the matching teeth of the operating cable. The operating cable resists bending and can resist tensile loads. In this way, the operating cable acts like a flexible rack of teeth that engages each of the sliding elements while still maintaining the distance between sliding elements as the cable is pushed or pulled. To shift the sliding elements, the operating cable can be shifted translationally within the guide rail, i.e. pushed into the guide rail or pulled out of it. The sliding elements are connected to each other through the sunshade. Because there is no direct connection between the sliding elements themselves, they may be moved translationally into the collecting space to save space. The sunshade hangs loosely between the individual sliding elements or, alternatively, rests at the bottom of the collecting space.

According to a preferred embodiment, the operating cable is fashioned with a worm gear while the sliding elements have a worm. In such an embodiment, the operating cable may be rotated within the guide rail to act like a worm gear drive so that the sliding elements are pushed forward or to the rear of the sunshade assembly.

According to another preferred embodiment of the invention, the sliding elements are connected by a connection resistant to bending. The teeth of the operating cable then engage the foremost of the sliding elements of each guide rail to shift these elements in a translational direction with the movement of the operating cable. In this way, the operating cable may push the sunshade into the collecting space while still maintaining the tautness of the sunshade. When the sliding elements enter the collecting space, they are folded one on top of the other in a space-saving manner. A plate spring may connect the sliding elements in this embodiment. By biasing the plate springs in alternatingly opposite directions, the sliding elements may be collected in the collecting space in a zigzag stack.

### BRIEF DESCRIPTION OF THE DRAWINGS

FIG. 1 schematically shows a perspective view of a vehicle roof, including a sunshade assembly.

FIG. 2 is a sectional view of the vehicle roof of FIG. 1 along plane II-II of FIG. 1.

FIG. 3 shows a sunshade assembly according to a first embodiment of the invention in a section along plane III-III of FIG. 1.

FIG. 4 shows the sunshade assembly of the first embodiment in a section along plane IV-IV of FIG. 2.

FIG. 5 is a sectional view along plane V-V of FIG. 4.

FIG. 6 is a sectional view similar to the view in FIG. 4, but showing some movement.

FIG. 7 is a detailed view of portion VII as shown in FIG. 6, on an enlarged scale.

FIG. 8 shows a sunshade assembly according to a second embodiment of the invention.

FIG. 9 is a section view along plane IX-IX of FIG. 8.

FIG. 10 shows a schematic sectional view of the collecting space of the sunshade assembly of the second embodiment.

FIG. 11 shows a sunshade assembly according to a third embodiment of the invention.

FIG. 12 shows a section along plane XII-XII of FIG. 11.

FIG. 13 shows a schematic sectional view of the collecting space of the sunshade assembly of the third embodiment.

### DETAILED DESCRIPTION OF THE PREFERRED EMBODIMENT

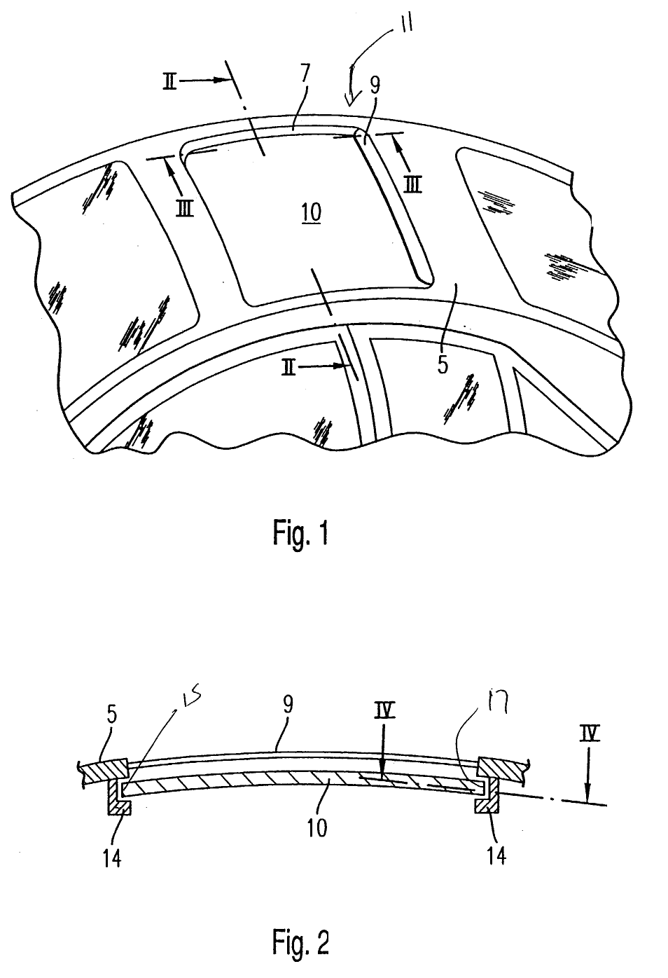

FIG. 1 schematically shows a vehicle roof 5, which has a roof opening 7. The roof opening 7 may be closed as known by a cover part 9, which is shown in FIG. 1 in an open position 11, e.g., a position moved to the rear of a vehicle. The cover part 9 is made of a transparent material to permit light such that it passes light.

As seen in FIG. 2, arranged underneath the cover part 9 is a sunshade 10. The sunshade 10 is preferably made of fabric or plastic and is guided by guide rails 14, which extend along left hand lateral edge 15 and right hand lateral edge 17 of the sunshade 10. The two guide rails 14 extend opposite and parallel to each other along lateral edges of roof opening 7. The lateral edges are defined as extending in a lengthwise (longitudinal) direction of the vehicle.

As shown in FIG. 5, each guide rail 14 has two neighboring channels: an accommodation channel 16 that accommodates an operating element 18, such as a cable, and a guide channel 20, to retain sliding elements 22.

The operating element 18 is a (non-elastic) cable, which is guided lengthwise along the vehicle. Element 18 is resistant to bending and can resist a tensile load. As seen in FIG. 7, on its outer surface, the cable has mating teeth 24 in the form of a round thread or a worm. The operating element 18 can be shifted within the accommodation channel 16 lengthwise to the vehicle as indicated by arrows of FIG. 7. A drive device (not illustrated) moves the operating element 18 in this way. The drive device may also move the other operating element located in the opposite guide rail in the same way, such that the two operating elements move at the same speed and in the same direction. Since the element 18 can resist tensile force, the drive device can move the element 18 forwardly even though its forward end is not being driven.

The sliding elements 22 are guide pieces for the sunshade 10, which are preferably made of plastic and directly applied onto the fabric of the sunshade. Preferably, sliding elements 22 are injection-molded to the sunshade 10 such that they are firmly attached. Each of the sliding elements 22 has a shape of a short cylinder, which is spaced from its neighboring sliding element 22 by a distance that is a multiple of a length of the cylinder. Each sliding element 22 carries an entrainment device on its outer surface. The entrainment device establishes a connection between the sliding element 22 and the operating element 18. In this arrangement, the entrainment device comprises teeth 26 (see FIG. 7), which mate with teeth 24 of the operating element 18.

The accommodation channel 16 and the guide channel 20 are arranged to be close enough to each other so as to overlap each other, i.e. there is no parting wall between them. In this way, teeth 26 of each of the sliding elements 22 engage the mating teeth 24 of the operating element 18 so that the sliding elements are entrained by the operating element 18 when moved within accommodation channel 16. The sunshade 10, which is connected to the sliding elements 22, extends from the guide channel 20 through a slot 28 in the guide rail 14 into the space between the guide rails 14.

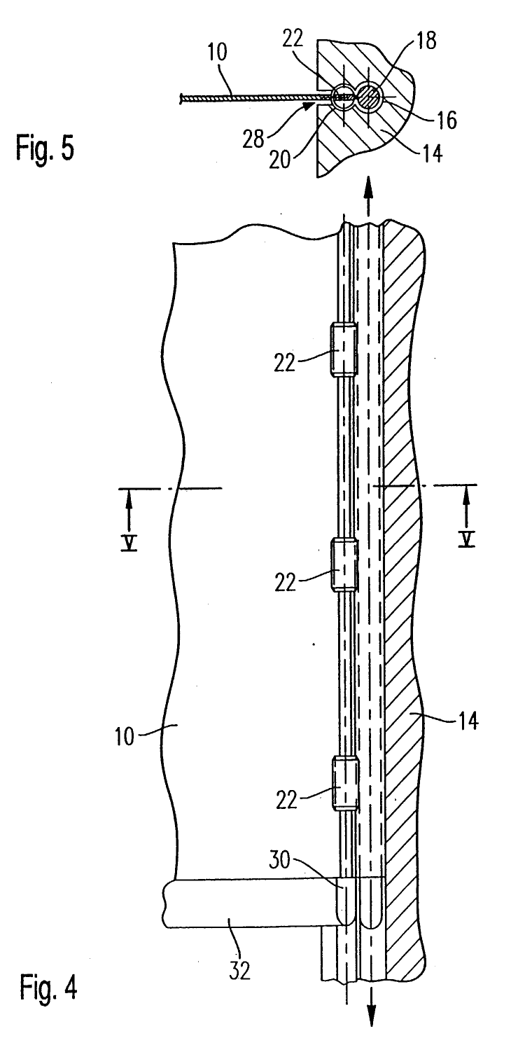

As seen in FIG. 4, attached to the front edge of the sunshade 10 is an end part 30, which slides in the guide channel 20 of the guide rail 14 in the same manner as the sliding elements 22. End part 30 has no teeth, however. Instead, the end part 30 is firmly connected with the operating element 18. Further, there is an arch 32, which is firmly connected between the two end parts 30 found in the two spaced guide channels 20. The arch 32 extends between the two end parts 30 and forms the front edge of the sunshade 10. As seen relative to the vehicle, the arch 32 is preferably arched in an upward direction to adapt to the profile of the arched vehicle roof. In this way, the sunshade 10 likewise assumes an arched shape, as seen in FIG. 2. If necessary, further arches 32 may extend between each pair of opposing sliding elements 22.

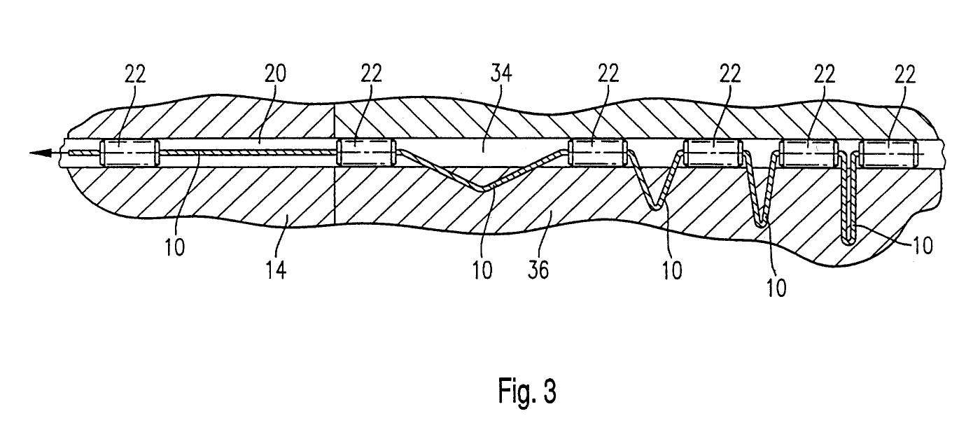

The two guide rails 14 merge into a collecting space 34 towards the rear of the direction of travel of the vehicle. In the first embodiment, the collecting space 34 is formed by a collecting rail 36 (see FIG. 3). Here, the collecting space 34 is a continuation of the guide channel 20 of the guide rail 14. Because sliding elements 22, are pushed together into the collecting rails 36 so that they almost rest against each other, the sunshade 10 is received in the region between a pair of collecting rails 36, lying opposite each other.

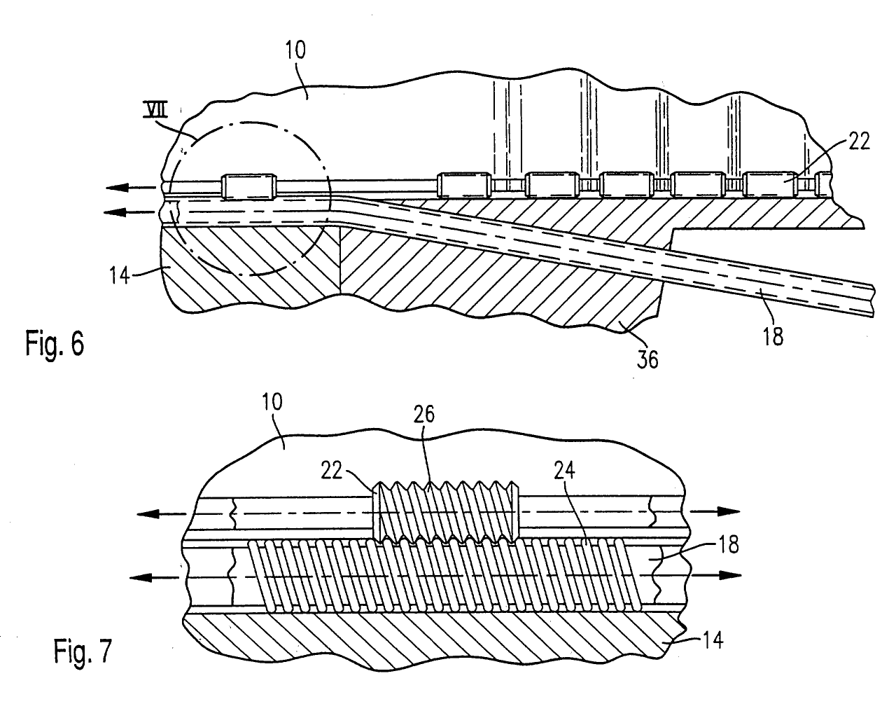

As can be seen in FIG. 6, the operating element 18 extends through the collecting rail 36 obliquely away from the sliding elements 22 once it has exited accommodation channel 16 of the guide rail 14. In this way, an engagement between teeth 26 of the sliding elements 22 and the mating teeth 24 of the operating element 18 arises only when the sliding elements 22 are located in the guide rail 14. As soon as the sliding elements 22 are located in the collecting rail 36, they are decoupled from the operating element 18.

As long as the sunshade 10 is in its open position 11, namely when the arch 32 is located at the rear edge of the roof opening 7 of the vehicle roof 5, all sliding elements 22 are arranged in the collecting space 34 of the collecting rail 36. At this moment, the sunshade 10 has assumed its most compact shape in the lengthwise direction of the vehicle. When the sunshade 10 is then closed from this open position 11, the two operating elements 18 on each side of the roof opening 7 are together pushed forward in the guide rail 14 thereby pushing the end part 30 in a forward direction in the guide rail 14. Consequently, the slack part of the sunshade 10 in collecting rail 36 will increase in tension until the sunshade transmits a tensile force to the first pair of sliding elements 22 to overcome any friction holding them in place and thereby pull them in a forward direction.

As soon as the first pair of sliding elements 22 moves from the collecting space 34 into the guide channel 20 of the guide rail 14, teeth 26 of the sliding elements 22 engages mating teeth 24 of the operational element 18, thereby defining a distance between end part 30 and the first pair of sliding elements 22. If the operating element 18 is pushed further into the guide rail 14, all pairs of sliding elements 22 will be sequentially pulled into guide rail 14. The tension across the sunshade 10 in the lengthwise direction of the vehicle is determined by the frictional force of the sliding elements 22 in the collecting rail 36. The larger this frictional force, the larger the force in the forward direction required before the corresponding sliding element 22 can be pulled out of collecting rail 36 and into guide rail 14. This frictional force along the guide rail 14 need not be maintained because of the engagement between the teeth 26 of the sliding elements 22 and the mating teeth 24 of the operating element 18. Moreover, friction can be adjusted by adjusting the number of sliding elements 22.

When the sunshade 10 is pushed back into the open position 11, both operating elements 18 will be pulled together out of the guide rails 14 in parallel. In so doing, the sunshade 10 is uniformly pushed back in the region between the guide rails 14, because the sliding elements 22 engage the operating element 18 at defined positions. As a consequence, the sunshade 10 remains taut in the region between the guide rails 14, even when pushed back. Only when the sliding elements 22 enter the collecting rail 36 sequentially and are then decoupled from the operating element 18 will the sunshade 10 slack in this region and be pushed together. When the end part 30 is located at the end of the guide rail 14, the sunshade 10 is pushed completely rearwardly. The two operating elements 18 cannot be pushed further back because the two end parts 30 are firmly connected with the operating elements 18.

While the cross-section of the accommodation channel 16 and the guide channel 20 are shown as circular, other cross-sectional shapes may be used. These other cross-sectional shapes need only ensure that the entrainment device on the sliding elements 22 can be brought into and out of engagement with the operating element 18. To this end as in the first embodiment, a directional change of the operating element 18 acting as a flexible toothed rack is particularly suitable.

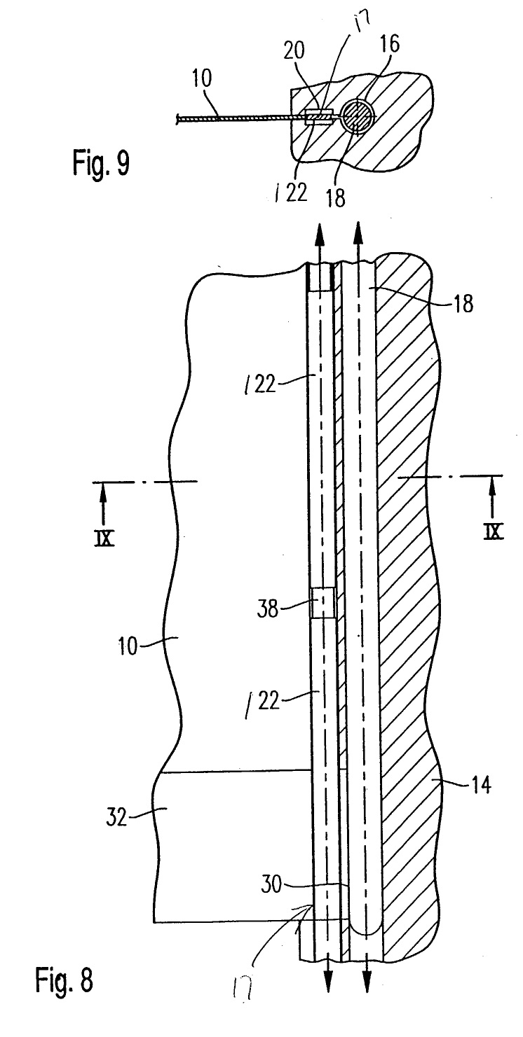

FIGS. 8 to 10 illustrate a sunshade assembly according to a second embodiment. The same reference numerals will be used for the components known from the first embodiment. Reference is made to the explanations above.

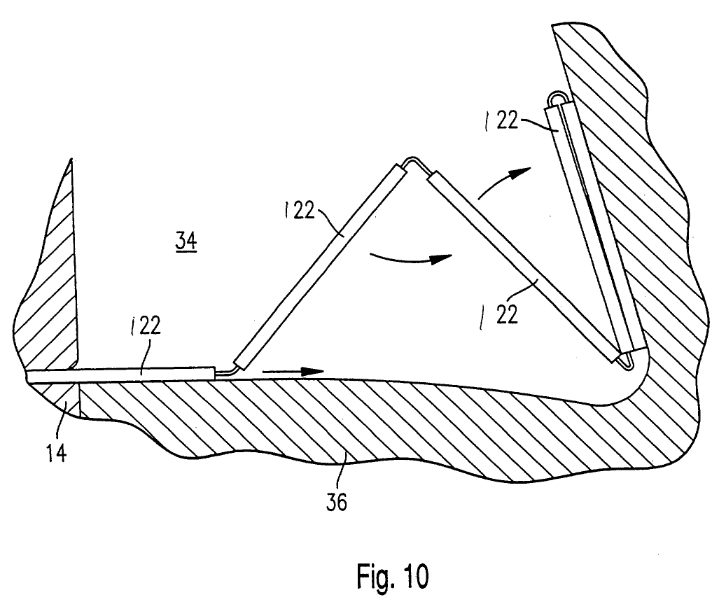

Like the first embodiment, the second embodiment uses an operating element 18, which can resist tensile loads and may resist bending. The operating element 18 can be pushed into or pulled out of the accommodation channel 16 of the guide rail 14 in the lengthwise direction of the vehicle. The sunshade 10 likewise has lateral edges 15, 17 provided with sliding elements 122, which are movably received in the guide channel 20 of the guide rail 14. Unlike the first embodiment, the sliding elements 122 of the second embodiment are much longer and the spacing between them is a fraction of their length. The sliding elements 122 are also connected by a connection that is resistant to bending. Here, this connection is a plate spring 38. Furthermore, the operating element 18 is not in engagement with the sliding elements 122 but is connected with the sunshade by the end part 30 only. As shown in FIG. 10, a further difference to the first embodiment is that the accommodation space 34 is much larger so that the sliding elements 122, while in the accommodation space 34, can be freely folded one on top of the other.

When the sunshade is in its open position all sliding elements 22 are in the collecting space. When moving to the closed position in which the roof opening 7 is covered, the two end parts 30 are pushed forward by means of two operating elements 18 in the guide rails 14. In so doing, the sliding elements 122 are sequentially pulled into the guide channel 20 in the guide rail 14. The resulting mechanical tension of the sunshade 10 is predefined by the mutual distance of the sliding elements 122, which distance is maintained by the plate springs 38, which serve as connections resistant to bending. Due to the connections between the individual sliding elements, the sunshade 10 need not have strength as high as in the first embodiment.

If the sunshade 10 is shifted from its closed position into the open position, the operating elements 18 are pulled out of the guide channel 20 of the guide rail 14. The movement of the operating elements 18 is transferred by the two end parts 30 and the plate springs 38 from one sliding element 122 to the next. Consequently, the sliding elements 122 will be pushed into the collecting space 34, starting with the rearmost sliding element 122. There, the sliding elements 122 will be folded one on top of the other in a space-saving manner, for example, in a zigzag form as shown in FIG. 10. The plate springs 38 are preferably biased in alternating directions, i.e. upwards and downwards, such that the sliding elements 122 will fold in this way. When all sliding elements 122 are pushed back into the collecting space 34, they will form a space-saving folded stack. The sunshade 10 will likewise be folded between the sliding elements 122.

In an alternative embodiment not illustrated in the drawings, there may be articulations between the sliding elements, instead of the plate springs. The folding direction of the sliding elements when entering the collecting space is predefined by these articulations.

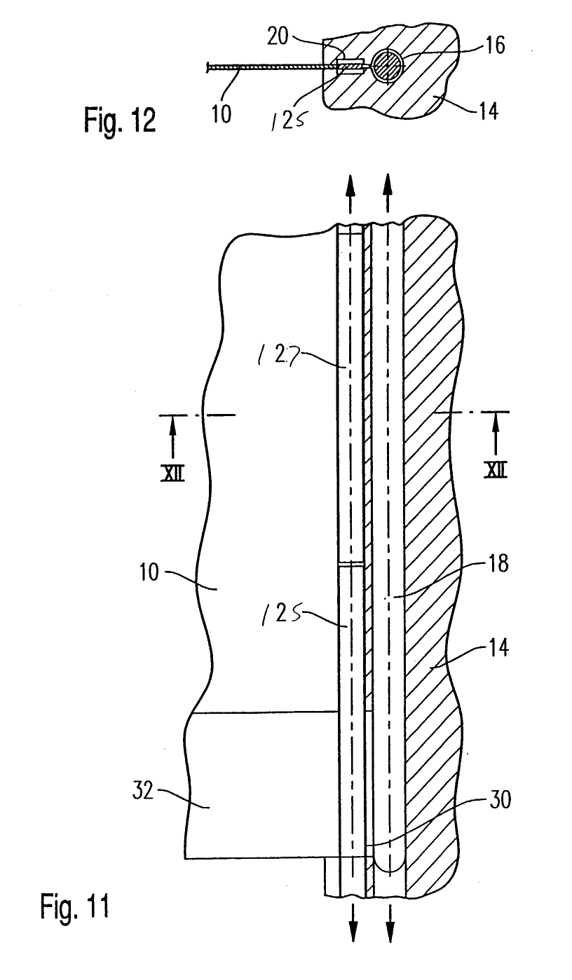

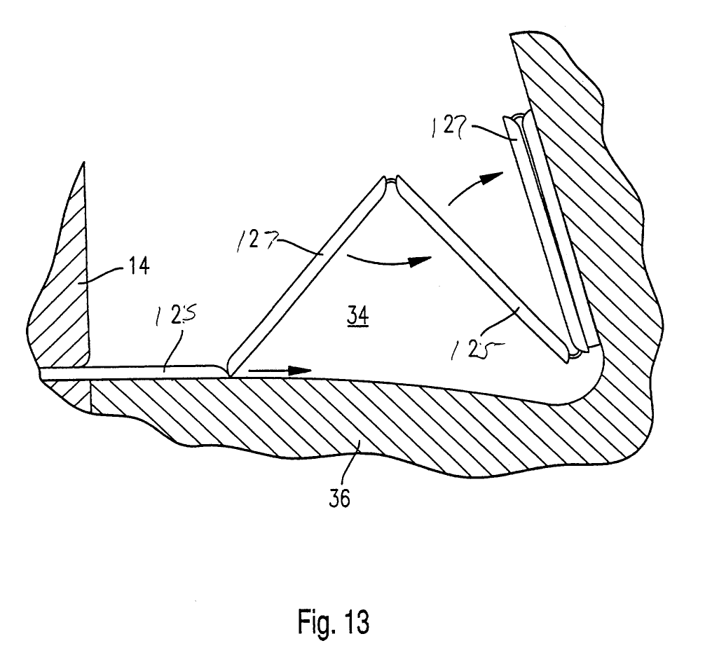

In FIGS. 11 to 13, a third embodiment of the invention is shown. The same reference numerals will be used for the components known from the first and second embodiments. Reference is made to the explanations above.

The third embodiment basically corresponds to the second embodiment. The difference between these two embodiments is that the third embodiment has the sliding elements directly adjoining each other without any interposed elements. The facing edges of the sliding elements 125 are rounded in design in alternating directions with a curvature that extends across 90 degrees. As seen from FIG. 13, the front edge of a sliding element 125 is rounded towards the bottom, while its rear edge is rounded towards the top. At the directly adjoining sliding element 127, the design is inverse: the front edge is rounded towards the top while the rear edge is rounded toward the bottom.

If the edges are designed in this way, it is possible to stack the sliding elements 125, 127 at very little cost in the same manner as the second embodiment. The sliding elements 125, 127 will fold up when entering the collecting space. In this case, the sunshade 10 articulates.

When the sunshade closes, the successive sliding elements 125, 127 are pulled into the guide rail 14 by means of the sunshade 10. When the sunshade 10 opens and moves back to the collecting space 34, the thrust force is transferred by the sliding elements 125, 127 resting against each other, whereby the sliding elements will fold up as soon as they are not guided by the guide rail any more and enter into the collecting space 34.

In an alternative embodiment not shown in the drawings, the contacting edges of the sliding elements are configured as hinges, i.e. one edge as swing support and the other one as a hinge pin. In this way, the design dictates in which direction the sliding elements will fold up in the collecting space.

The aforementioned description is exemplary rather than limiting. Many modifications and variations of the present invention are possible in light of the above teachings. The preferred embodiments of this invention have been disclosed. However, one of ordinary skill in the art would recognize that certain modifications would come within the scope of this invention. Hence, within the scope of the appended claims, the invention may be practiced otherwise than as specifically described. For this reason, the following claims should be studied to determine the true scope and content of this invention.

1. A sunshade assembly for a vehicle roof, comprising:
a first guide rail and a second guide rail, said first guide rail spaced from said second guide rail;
a sunshade movable relative to said first guide rail and said second guide rail between an open position and a closed position, said sunshade having a first lateral edge supported by said first guide rail and a second lateral edge supported by said second guide rail;
at least a first sliding element movable within said first guide rail and supporting said first lateral edge on said first guide rail and a second sliding element movable within said second guide rail and supporting said second lateral edge to said second guide rail; and
a collection space to receive said sunshade in said open position.

2. The sunshade assembly of claim 1, wherein said sunshade is made of fabric.

3. The sunshade assembly of claim 1, wherein said sunshade is made of a plastic sheet.

4. The sunshade assembly of claim 1, wherein at least one of said first sliding element and said second sliding element are injection molded to at least one of said first lateral edge and said second lateral edge.

5. The sunshade assembly of claim 1, wherein said first sliding element is connected to said second sliding element by an arch.

6. The sunshade assembly of claim 1, including an operating element for moving said sunshade between said open position and said closed position.

7. The sunshade assembly of claim 1 including an entrainment device entraining at least one of said first sliding element and said second sliding element to said operating element.

8. The sunshade assembly of claim 7, wherein said entrainment device comprises teeth on said at least one of said first sliding element and said second sliding element and matching teeth on said operating element.

9. The sunshade assembly of claim 6, wherein said operating element can be shifted within at least one of said first guide rail and said second guide rail.

10. The sunshade assembly of claim 8, including at least a third sliding element movable within said first guide rail and adjacent to said first sliding element and further including a flexible connection between said first sliding element and said third sliding element.

11. The sunshade assembly of claim 10 wherein said third sliding element stacks onto said first sliding element in said collecting space.

12. The sunshade assembly of claim 10 wherein said flexible connection comprises said sunshade.

13. The sunshade assembly of claim 10 wherein said flexible connection resists bending.

14. The sunshade assembly of claim 10 wherein said flexible connection comprises a plate spring.
